(19) United States
(12) Patent Application Publication
(10) Pub. No.: US 2005/0084729 A1
(43) Pub. Date: Apr. 21, 2005

(54) Device for cleaning waste gases for a direct alcohol fuel cell or for a fuel cell stack constructed therefrom

(76) Inventors: Hendrik Dohle, Stolberg (DE); Jurgen Mergel, Julich (JP)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/496,069

(22) PCT Filed: Nov. 12, 2002
(86) PCT No.: PCT/DE02/04166

(30) Foreign Application Priority Data
Nov. 21, 2001 (DE) 101 57 139.9

(51) Int. Cl. H01M 8/04

(52) U.S. Cl. 429/34; 429/13; 429/26

(57) ABSTRACT

The invention relates to a device for cleaning waste gases for a direct alcohol fuel cell or for a direct alcohol fuel cell stack, comprising at least one supply line for supplying an oxidizing agent into a cathode space of a fuel cell and at least one evacuation line for evacuating waste gas out of a fuel cell. The supply line and evacuation line are arranged next to one another at least in one area and are separated by a porous layer. A catalytic converter is placed on the surface of the porous layer oriented toward the evacuation line. In the inventive waste gas cleaning device, the advantages of an internal utilization of heat and of an at least partial water circuit with an effective catalytic conversion and reduction of removed non-converted alcohol, particularly methanol, locally unite at one location of the fuel cell system. The waste gas cleaning device simultaneously serves to preheat and wet the supplied oxidizing agent and can be advantageously provided with a very compact design.

The invention relates to a device for cleaning an exhaust gas, especially an exhaust gas arising at the cathode side of a direct-alcohol fuel cell or a fuel cell stack formed therewith.

### STATE OF THE ART

From DE 199 21 816 C1 a fuel cell system encompassing individual fuel cells is known. The system has in addition a disposal unit for receiving the waste products formed in the operation of the fuel cell. This is especially a filter unit and an ion exchange unit.

Through the filter unit it is advantageously possible to separate the waste products which arise from one another and to collect them separately which facilitates the subsequent disposal. This can be accomplished for example by converting the gaseous CO₂ which is produced at the anode to solid carbonate.

The ion exchange device disclosed in DE 199 21 816 C as the disposal unit initially transforms a waste product and then collects it in a receiving unit. In the fuel system which is described in DE 199 21 816 C1, the fuel side of the system can thus be advantageously completely decoupled from the environment in operation.

The drawback with this system however is that the waste products within the system are initially accumulated and then first removed from the system at a certain point in time.

### OBJECTS AND SOLUTION

The object of the invention is to provide an apparatus for cleaning gas of a PEM fuel cell which avoids undesired withdrawal of alcohol therefrom.

The object is achieved in an apparatus for the cleaning of the waste gas of a direct-alcohol fuel cell in accordance with the main claim by a method of operating such a fuel cell or a fuel cell stack in according with the auxiliary claim. Advantageous embodiments of the cleaning device, the fuel cell system and the method can be deduced from the respective dependent claims.

### SUBJECT MATTER OF THE INVENTION

The device according to the invention for waste gas cleaning of a direct-alcohol fuel cell combines the advantages of a heat exchanger with those of a waste air cleaner.

The device for waste gas cleaning encompasses a supply pipe for feeding an oxidation medium or agent to the cathode compartment of the direct-alcohol fuel cell and a discharge pipe for discharging a waste gas from the direct-alcohol fuel cell. The fuel and discharge pipes are arranged to approach one another at one region and there are separated from one another by a porous layer. Advantageously, the pipes or ducts are provided in counterflow in one embodiment.

The device for waste gas cleaning in addition comprises a catalyst which is arranged on the inner side of the discharge pipe or conduit in the region of the porous layer. This catalyst converts as a rule the unconsumed alcohol, especially methanol together with excess atmospheric oxygen into less detrimental products like for example water CO₂. As a catalyst suitable for that purpose, platinum and/or palladium can be mentioned. During the operation of a direct-alcohol fuel cell, it is common practice to prevent a significant part of the fuel, that is the alcohol, especially methanol from passing by diffusion through the polymer-electrolyte membrane (PEM) into the cathode space. Especially with direct-methanol fuel cells, this problem is known as methanol crossover in knowledgeable circles.

Optionally, the anode can also be connected to this waste gas line. In that case, the CO₂ which arises at the anode and which usually also contains unreacted alcohol can be cleaned in the cleaning unit.

The catalytic conversion of the still unreacted methanol in the waste gas of the fuel cell by the cleaning unit is advantageously accelerated by the intrinsic heat of the exhaust air. The exhaust air can arise from a cathode space and/or from an anode space of one or more fuel cells.

In an advantageous configuration of the cleaning device, the porous layer is formed as a water-permeable membrane. This enables an advantageous moisturization of the supplied oxidizing agent through the passage of water which may be in the form of liquid water or steam in the exhaust gas through the membrane on the oxidizing agent side. Since the supplied air (oxidizing agent) is as a rule less water-saturated than the waste gas, because of the concentration gradient, there is usually a diffusion of water through the membrane into the drier supplied air.

Furthermore, the heat transfer is improved by the passage of the liquid water or steam in an advantageous manner. Suitable materials for such a water permeable membrane are for example Nafion™ or membranes based upon silicones.

In a configuration of the cleaning unit which is also advantageous, the porous layer, for example the water permeable membrane, is configured to be additionally oxygen permeable. In this manner an additional air or oxygen input from the oxidizing agent pipe through the both water permeable and/or permeable membrane into the waste air line is enabled. As a consequence there is an effective catalytic conversion of the undesired alcohol in the waste gas.

In the apparatus according to the invention for waste gas cleaning, there is a unification of the advantages of an internal heat utilization and an at least partial water circulation with an effective catalytic conversion and a reduction of unreacted alcohol entrained out of the system, locally at one place in the fuel cell system. The waste gas cleaning which simultaneously functions as a heat exchanger and moisturizing unit for supplied oxidizing agent can advantageously be especially compact.

### SPECIAL DESCRIPTION PART

In the following, subject matter of the invention is described in greater detail in conjunction with Figures without thereby limiting the subject matter of the invention.

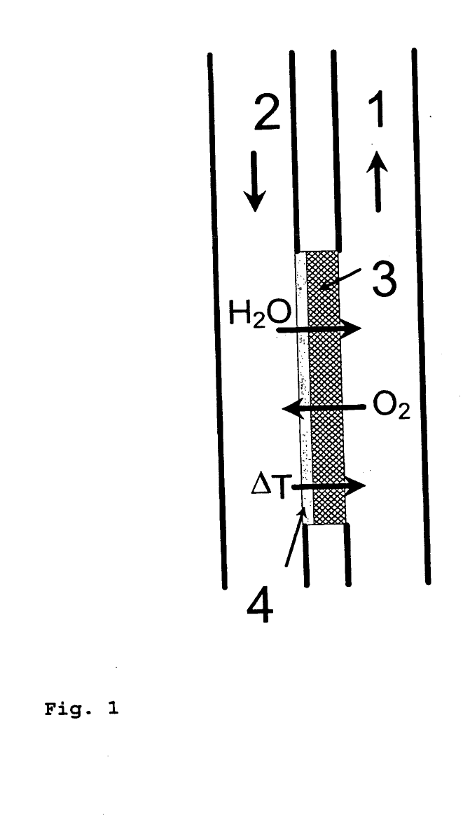

FIG. 1 shows schematically the device according to the invention for gas cleaning. A supply line [duct] 1 for supplying an oxidizing agent to the cathode compartment of a fuel cell and a waste air line [duct] 2 for discharging a waste gas from a fuel cell are arranged at least partly parallel to one another and in this region are separated by a porous layer 3. Advantageously ducts are so arranged that they are operated with gas passage directions in counterflow. On the waste gas duct side of the porous layer 3, there is provided a catalyst for the conversion of the alcohol in the waste gas and which has been incompletely reacted in the fuel cell.

The arrows mark the direction of the streams (water and oxygen) and the heat transport through the porous layer.

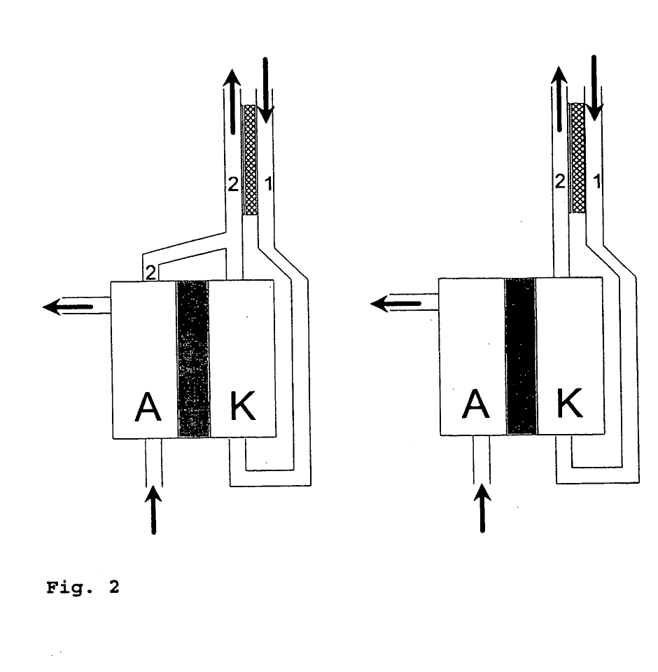

FIG. 2 shows two embodiments of the cleaning device of the invention which re associated with respective fuel cells. In the right-hand Figure, the device for cleaning the waste gas is disposed latch feed and discharge ducts for the oxidizing agent at the cathode side. However, an arrangement is also possible as has been indicated at the left in FIG. 2. The anode waste gas especially CO₂ which is formed in the fuel cell is together with quantities of water vapor and alcohol, especially methanol, fed to the cathode waste gas and then the two are supplied together to the device according to the invention for waste gas cleaning.

With fuel cell stacks, an arrangement of the apparatus for waste gas cleaning in so-called manifold passages is possible instead of in the individual supply and discharge passages for each fuel cell.

1. A device for the waste gas cleaning for a direct-alcohol fuel cell for a fuel cell stack composed thereof, comprising at least one supply duct (1) for supplying an oxidizing agent to a cathode space of the fuel cell and at least one discharge duct (2) for discharging waste gas from the fuel cell, characterized by,
a) a region in which he supply duct and the discharge duct are disposed at least partly adjacent one another and are separated by a porous layer (3) and
b) a catalyst (4) which is applied to the surface of the porous layer (3) which is directed toward the discharge duct (2).

2. The device for gas cleaning according to claim 1 whereby the porous layer is formed from a water-permeable membrane.

3. The device for waste gas cleaning according to claim 1, whereby the porous layer additionally is configured to be oxygen permeable.

4. The device for waste gas cleaning according to claim 1 in which the waste gas duct is configured to discharge waste gas both from an anode compartment and from a cathode compartment.

5. The device for waste gas cleaning according to claim 1 in which the catalyst is capable of catalyzing a methanol conversion.

6. A direct alcohol fuel cell with at least one device for waste gas cleaning according to claim 1.

7. A fuel cell stack with at least two direct alcohol fuel cells and at least one device for the gas cleaning in accordance with claim 1.

8. A method of operating a direct alcohol fuel cell or direct alcohol fuel cell stack with at least one device or waste gas cleaning according to claim 1 with the steps of
a) feeding the waste gas from at least one fuel cell through a waste gas duct which is connected through a porous layer to a supply duct for feeding an oxidizing agent to at least one fuel cell,
b) feeding a heat transfer from the waste gas through the porous layer to the catalyst,
c) transforming by the catalyst, alcohol present in the waste gas at least partly into water and CO₂.

9. The method according to preceding claim 8, whereby in addition water from the waste gas located in the waste gas duct diffuses through the porous layer which is formed as a water permeable membrane into the supply duct, and the oxidizing agent located in the supply duct at least partly picks up the water.

10. The method according to claim 8, whereby additionally oxygen from the oxidizing agent located in the supply duct diffuses through the porous layer which is configured as an oxygen permeable membrane into the waste gas located in the waste gas duct and there serves for catalytic conversion of the alcohol.
